(19) United States
(12) Patent Application Publication
(10) Pub. No.: US 2013/0103604 A1
(43) Pub. Date: Apr. 25, 2013

(54) Currency System for Giving

(71) Applicants: William Weisman, Minneapolis, MN (US); Michael Dominowski, Minneapolis, MN (US); Nate Garvis, Minneapolis, MN (US); Sheila Kim, Minnetonka, MN (US)

(72) Inventors: William Weisman, Minneapolis, MN (US); Michael Dominowski, Minneapolis, MN (US); Nate Garvis, Minneapolis, MN (US); Sheila Kim, Minnetonka, MN (US)

(21) Appl. No.: 13/655,861

(22) Filed: Oct. 19, 2012

Related U.S. Application Data
(60) Provisional application No. 61/550,157, filed on Oct. 21, 2011.

(51) Int. Cl. G06Q 40/00

(52) U.S. Cl. 705/329

(57) ABSTRACT

In one aspect, a method for implementing a currency system for giving includes: receiving a donation to a donor-advised fund; converting, by a computing system, the donation to an intermediate currency different than a currency of the donation; receiving, at the computing system, instruction designating a gift for distribution to a recipient organization, the gift including at least a portion of the donation in the intermediate currency; and transferring, from the computing system, the gift to the recipient organization.

### RELATED APPLICATION(S)

This application claims the benefit of U.S. Patent Application Ser. No. 61/550,157 filed on Oct. 21, 2011, the entirety of which is hereby incorporated by reference.

### BACKGROUND

Organizations are frequently interested in identifying ways to motivate people. One method for motivating an individual may include providing experiences that recognize the person as an individual, while also providing a feeling of meaning, connection, and a sense of well-being. Charitable giving is recognized as providing such benefits. Accordingly, it may be desirable to provide a reward mechanism that promotes altruistic behavior, the benefits of which may be realized by all involved parties.

### SUMMARY

The present disclosure is directed to systems and methods for implementing a currency system for giving.

In one aspect, a method for implementing a currency system for giving is disclosed. The method comprises: receiving a donation to a donor-advised fund; converting, by a computing system, the donation to an intermediate currency different than a currency of the donation; receiving, at the computing system, instruction designating a gift for distribution to a recipient organization, the gift including at least a portion of the donation in the intermediate currency; and transferring, from the computing system, the gift to the recipient organization.

In another aspect, a computing device comprising a processing unit and a system memory connected to the processing unit is disclosed. The system memory includes instructions that, when executed by the processing unit, cause the processing unit to execute an application configured to implement a currency system for giving including: receive a donation to a donor-advised fund; convert the donation to an intermediate currency different than a currency of the donation; receive a first trigger message, the first trigger message at least including specification of an designee and an awarded currency amount; receive instruction designating a gift for distribution to a recipient organization, the gift at least corresponding to the awarded currency amount and including at least a portion of the donation in the intermediate currency; and transfer the gift to the recipient organization.

In yet another aspect, a computer-readable storage medium having computer-executable instructions is disclosed that, when executed by a computing device, cause the computing device to perform steps comprising: receiving a donation to a donor-advised fund; converting the donation to an intermediate currency different than a currency of the donation; receiving a first message, the first message specifying a designee, an awarded currency amount in the intermediate currency, and an award criterion designating a reason that the designee is awarded the awarded currency amount; receiving instruction from the designee for distribution of gift representing at least a portion of the intermediate currency to a recipient organization; transferring the gift to the recipient organization; and sending a second message to the designee acknowledging the gift to the recipient organization.

### DESCRIPTION OF THE DRAWINGS

FIG. 1 shows a flowchart for an example method for implementing a currency system for giving.

FIG. 2 is a flowchart illustrating additional aspects of the method shown in FIG. 1.

FIG. 3 is a flowchart illustrating additional aspects of the method shown in FIG. 1.

FIG. 4 shows an example networked computing environment.

FIG. 5 shows an example computing device of the environment of FIG. 4.

FIG. 6 shows example communications between the computing devices of FIG. 4.

FIG. 7 shows example logical modules of a software application configured for implementing a currency system for giving.

### DETAILED DESCRIPTION

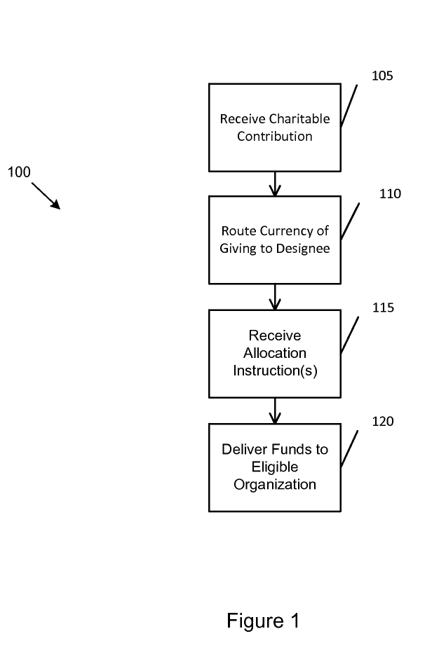

FIG. 1 shows an example method 100 for implementing a system for giving in accordance with the present disclosure.

In this example, the system will be described with relation to a corporation and employee. However, as discussed, the system is not so limited. In other embodiments, other types of contributors and designees can be accommodated by the system.

The method 100 begins at an operation 105, in which a corporation or other entity (“contributor”) makes a charitable contribution to the system. In this example, the system can act as a donor-advised fund (DAF) managed by a 501(c)(3) public charity non-profit organization (NPO). In general, such an NPO has the ability to re-appropriate funds to other approved organizations based on instructions given by a particular designee donor associated with the contribution (e.g., an employee of the contributor). In this manner, the particular donor has advisory rights as to how the contribution is ultimately allocated.

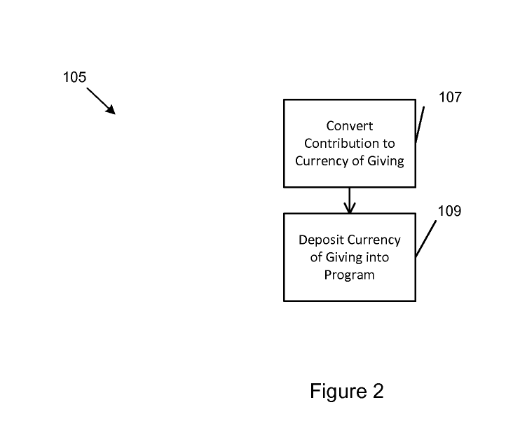

Referring now to FIG. 2, additional details of step 105 are shown. In this example, at operation 107, the system converts the charitable contribution into another unit of measure, such as a separate currency (“currency of giving”) based upon an exchange rate. The conversion is optional, and in general is a mapping of the charitable contribution into another unit of measure. In one example, the currency of giving is assigned a value of one (1) U.S. dollar. Other embodiments are possible. For example, the exchange rate may vary based on type of currency used for the contribution (e.g., pound sterling, euro, etc.), an exchange policy exacted by the system in accordance with rules of the DAF, and/or a desired exchange rate set according to system policies or contributor requests (e.g., a conversion of 1:2; 1:5, etc.).

Next, at operation 109, the currency of giving is deposited into a program associated with the contributor. In addition, in the current example, the contributor may be entitled to a tax deduction, along with a corresponding amount of currency of giving, in return for the charitable contribution.

Referring again to FIG. 1, at operation 110, the currency of giving is then distributed to certain designees. The allocation of the currency of giving can be performed according to predefined rules set by the contributor and/or system policies. In other examples, a portion of all of the currency of giving can be held in trust until additional distribution rules are provided by the contributor. In this example, the currency of giving can be distributed to employees of the corporation based on “programs” that define certain award criteria (e.g., performance measures, employment anniversaries, wellness activities, etc.). However, as described further below, other distributions are possible. For example, other organizations can distribute to members or other individuals. In yet another example, individuals can purchase currency for themselves and/or others to distribute.

Upon distribution, a designee, such as a particular employee in the example described herein, may then advise the system as to how his or her respective currency of giving should be allocated to approved organization(s).

For example, at an operation 115, the system receives instruction from an employee of the corporation as to how his/her respective currency of giving should be distributed to a charitable organization(s). In one embodiment, the system provides an Internet-accessible listing of approved organizations by which the employee is afforded the opportunity to select a charitable organization(s) of their choice. Other embodiments are possible.

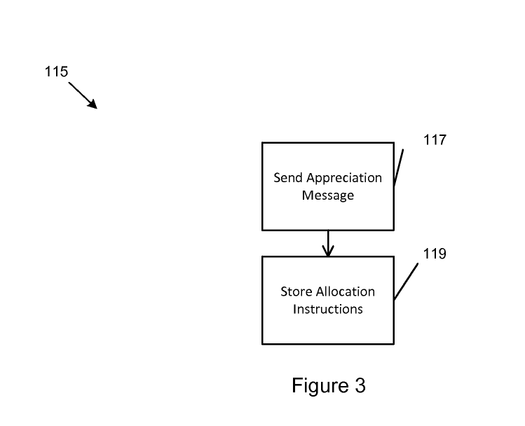

Referring now to FIG. 3, additional details about operation 115 are provided. At operation 117, an appreciation message is sent to the designee after the system receives the allocation instructions. In this manner, the designee receives confirmation that the system has received the instructions and is encouraged to continue to participate in the use of the system.

Next, at operation 119, the allocation instructions are stored in the system prior to allocation to the designated entities. For example, as described further below, the system can store allocations and periodically distribute funds to specific entities. In another example, the system can be configured to allow distribution of the funds to the designated organization, or allow the organization to receive the charity of currency that can, upon request, be converted back to a negotiable currency (e.g., U.S. dollars).

Referring now back to FIG. 1, at an operation 120, the system transfers funds to the organization according to the allocation instructions from the designee received at operation 115. In general, these funds may correspond to currency of giving, U.S. dollar currency, or any combination thereof. In event that the funds at least partially correspond to currency of giving, the organization that ultimately receives the gift or donation will work with the NPO to exchange the currency of giving based on an appropriate exchange rate and/or exchange policy exacted by the NPO.

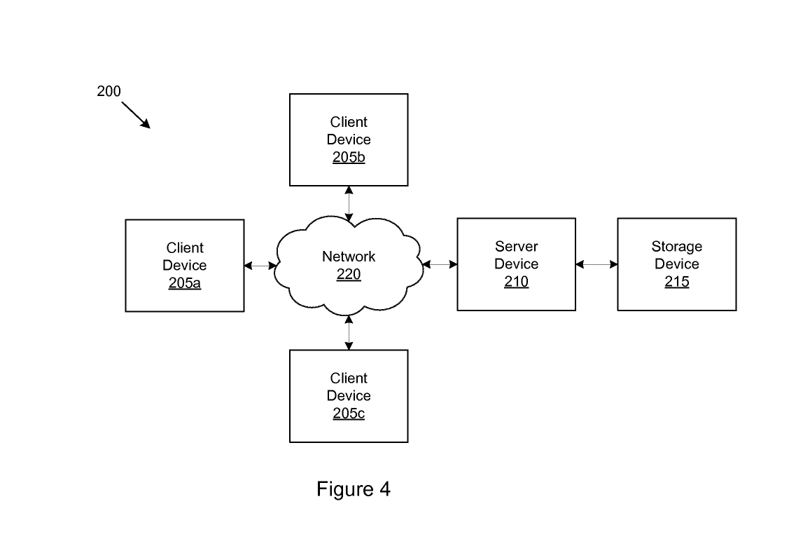

One example implementation of the method 100 is described below in connection with FIGS. 4-7, which illustrate an example computing environment that is programmed to implement the method 100.

Referring now to FIG. 4, an example networked computing environment 200 is shown in which aspects of the present disclosure, including the example method 100 of FIG. 1, may be implemented. The example environment 200 includes a plurality of client devices 205a-c (collectively, client device 205), a server device 210, a storage device 215, and a network 220. Other embodiments are possible. For example, the environment 200 may generally include more or fewer devices, networks, and other components as desired.

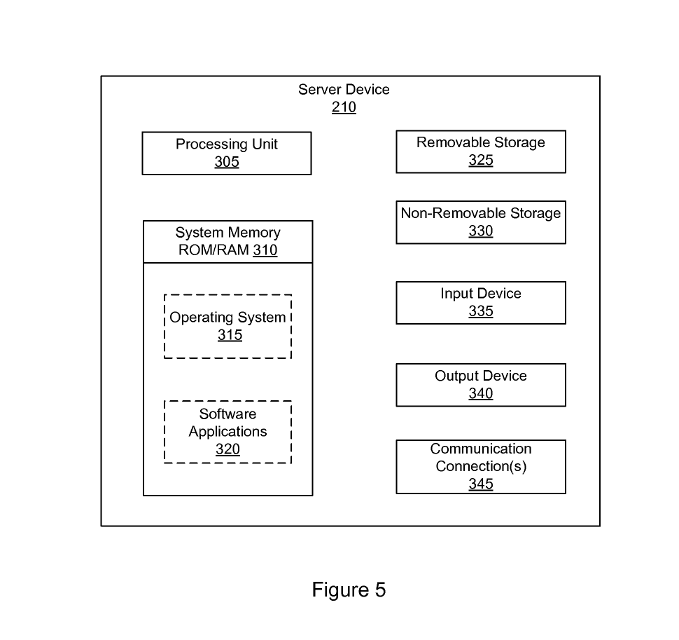

The client device 205 and the server device 210 are computing devices, described in further detail below in connection with FIG. 5. In example embodiments, the server device 210 is configured as a business server that executes business processes for implementing a currency system for giving. For example, the server device 210 can manage the issuance and spending of currency of giving. The business processes as executed by the server device 210 are accessible to the client device 205. Other embodiments are possible.

The storage device 215 is an electronic data storage device, such as a relational database or any other type of persistent data storage device. The storage device 215 stores data in a predefined format such that the server device 210 can query, modify, and manage data stored thereon. Other embodiments are possible.

The network 220 is a bi-directional data communication path for data transfer between one or more devices. In the example shown, the network 220 establishes a communication path for data transfer between the client device 205 and the server device 210. The network 220 can generally be of any number of wireless or hardwired WAN, LAN, Internet, or other packet-based communication networks such that data can be transferred among the elements of the example environment 200. Other embodiments are possible.

Referring now to FIG. 5, example hardware and software components of the server device 210 of FIG. 4 are shown in detail. As mentioned above, the server device 210 is a computing device. An example computing device includes an enterprise server, blade server, desktop computer, laptop computer, personal data assistant, smartphone, gaming console, and others.

The server device 210 includes at least one processing unit 305 and at least one system memory 310. The system memory 310 stores an operating system 315 for controlling the operation of the server device 210 and/or another computing device (e.g., client device 205). The system memory 310 also includes one or more software applications 320. Software applications 320 may include many different types of single and multiple-functionality programs, such as a server program, an electronic mail program, an Internet browser program, a spreadsheet program, a program to track and report information, a word processing program, and many others.

The system memory 310 is computer-readable media. Examples of computer-readable media include computer storage media and communication media. Computer storage media is physical media that is distinguished from communication media.

Computer storage media includes physical volatile and nonvolatile, removable and non-removable media implemented in any method or technology for persistent storage of information, such as computer-readable instructions, data structures, program modules, or other data. Computer storage media also includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to persistently store desired information and which can be accessed by the server device 210. Any such computer storage media may be part of or external to the server device 210. Such storage is illustrated in FIG. 5 by removable storage 325 and non-removable storage 330.

Communication media is typically embodied by computer-readable instructions, data structures, program modules, or other data, in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media.

The server device 210 also includes any number and type of an input device 335 and output device 340. An example input device 335 includes a keyboard, mouse, pen, voice input device, touch input device, motion input device, and others. An example output device 340 includes a display, speakers, printer, and others. The server device 210 also includes a communication connection 345 configured to enable communications with other computing devices over a network (e.g., network 220 of FIG. 4) in a distributed computing system environment.

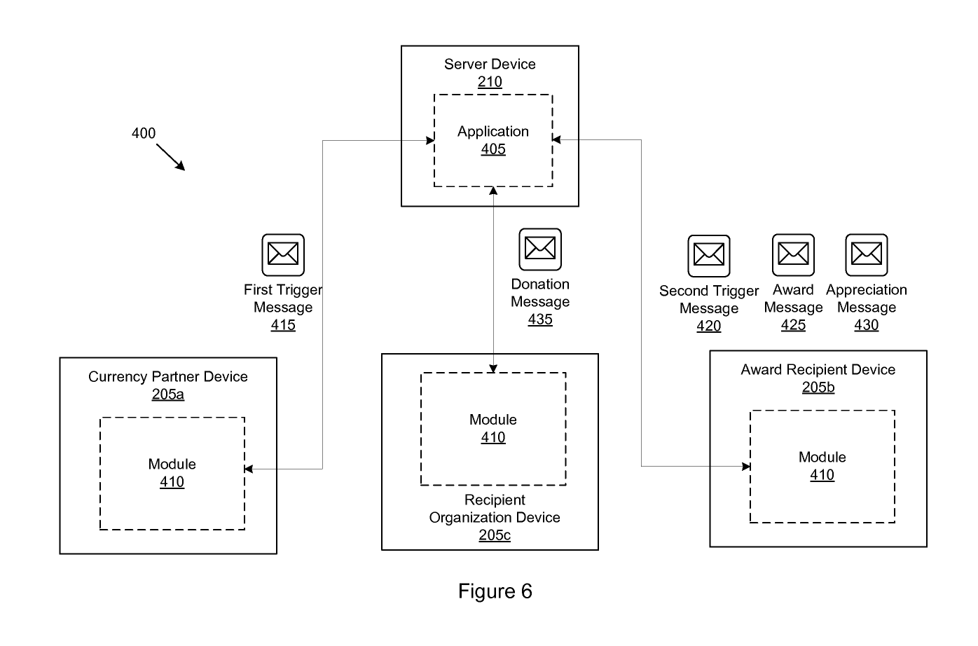

Referring now to FIG. 6, a schematic block diagram 400 illustrates example communications between the client devices 205a-c and the server device 210 of FIGS. 4-5. Other configurations of the example diagram 400 are possible. For example, the schematic block diagram 400 may generally include more or fewer client devices, server devices, and other components as desired.

The server device 210 includes a platform or application 405 including logical modules of software configured for implementing a currency system for giving. The respective client devices 205a-c each include a module 410 including logical modules of software configured to interact with functionality of the application 405. This functionality can be browser-based and/or provide in one or more native applications running on desktop and/or mobile platforms. Other embodiments are possible.

In the example shown, the client device 205a is a device used by an individual associated with the contributor, such as a corporate representative authorized to distribute currency of giving to a particular designees, such as employees or other “designees” of the corporation, whereas the client device 205b is a device used by the designee, and the client device 205c is used by a charitable organization or “recipient organization” that ultimately receives a gift or donation from the designee. Other embodiments are possible.

In example embodiments, a first trigger message 415 is composed on the client device 205a via the corresponding module 410. Composition of the first trigger message 415 includes adding a currency of giving amount (e.g., 100 units) to be distributed to the designee in view of certain award criteria (e.g., 1 year employment anniversary). Other embodiments are possible for distributing currency of giving to the designee. For example, in some embodiments, the designee composes a second trigger message 420 on the client device 205b via the corresponding module 410. In this example, composition of the second trigger message 420 includes the designee purchasing a currency of giving amount (e.g., 50 units) for personal use, distribution among one or more other individuals (e.g., work colleague, family member, etc.), and/or any other purpose as desired. Still other embodiments are possible.

The first trigger message 415 (and/or the second trigger message 420) is transferred to application 405, which in turn generates an award message 425 that is transferred to the client device 205b. In example embodiments, the award message 425 specifies the awarded currency of giving amount (e.g., “You are awarded 100 charity dollars.”) and a description of the reason(s) for distribution of the currency of giving award (e.g., “Congratulations on your one (1) year employment anniversary.”). Subsequently, the designee accesses functionality of the application 405 via the corresponding module 410, and specifies that he or she would like at least part of the currency of giving award to be distributed as a charitable donation to the recipient organization. In example embodiments, this can be done by various methods, such as a voice call, email, text message, and/or transaction instructions provided through an application interface and/or web-based interface.

In response to specification of the charitable donation, the application 405 generates an appreciation message 430 that is transferred to the client device 205b. In example embodiments, the appreciation message 430 acknowledging the currency of giving donation to the recipient organization (e.g., “Thank you for the donation.”). The application 405 additionally generates a donation message 435 that is transferred to the client device 205c. In example embodiments, the donation message 435 specifies a currency of giving value of the donation (e.g., “You have received a 100 unit currency of giving donation.”) and optionally a value of the donation in real world currency based on an appropriate exchange rate and/or exchange policy (e.g., “The value of the 100 unit currency of giving donation corresponds to $99.”). Other embodiments are possible.

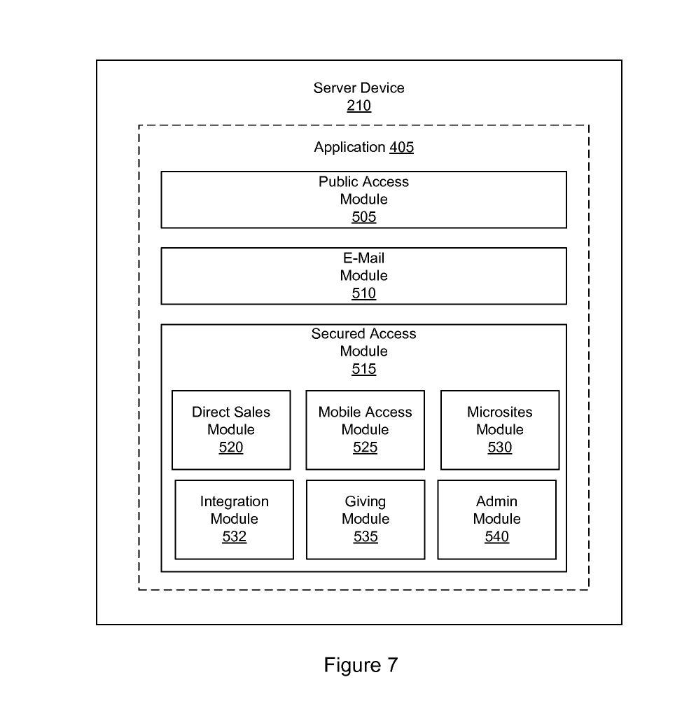

Referring now to FIG. 7, example logical modules of the application 405 executing on the server device 210 of FIGS. 4-6 are shown. In this example, the application 405 includes a public access module 505, an e-mail module 510, and a secured access module 515 each configured for implementing a currency system for giving. Other embodiments are possible. For example, the application 405 may generally include more or fewer modules as desired.

The public access module 505 is configured to implement public user interfaces of a web page for a 501(c)(3) public charity non-profit organization (NPO). One example of such an organization is Dotopia of Minneapolis, Minn. In this example, the public access module 505 implements web pages that at least include: (a) organizational information; (b) FAQs about the entity; and (c) learning pages that contain information about giving. Content on these respective web pages may also include: (a) social media icons/integration (e.g., Facebook, Twitter, LinkedIn, etc.); (b) presentation of information derived from RSS or other feeds from other organizations; and (c) animation and other multimedia content. Other embodiments are possible. For example, the public access module 505 may generally implement more or fewer public user interfaces as desired.

The e-mail module 510 is at least configured to send and receive, either via manual or automatic invocation, messages to and from client device 205a-c. Examples of such e-mail messages include the first trigger message 415, second trigger message 420, award message 425, and appreciation message 430 such as described above in connection with FIG. 6. Other embodiments are possible. For example, the e-mail module 510 may generally be configured to send and receive more or fewer types of messages as desired.

The secured access module 515 is configured to implement credential protected user interfaces of a web page for a 501(c)(3) public charity non-profit organization (NPO). The secured access module 515 at least implements: (a) a direct sales module 520; (b) a mobile access module 525; (c) a microsites module 530; (d) a giving module 535; and (e) an administrative module 540. Other embodiments are possible. For example, the secured access module 515 may generally include more or fewer modules as desired.

In example embodiments, the direct sales module 520 implements web pages directed towards business-to-consumer (B2C) e-commerce and providing individuals a direct channel to acquire currency of giving. The mobile access module 525 implements application programming interfaces (APIs) that are accessed by mobile applications (e.g., Windows, iOS, Android, etc.), widgets embedded on other sites, and other sites where developers are integrating the system as a payment type processor. Other embodiments of the direct sales module 520 and mobile access module 525 are possible,

The microsites module 530 is configured to implement a plurality of “co-branded” web pages that carry content (e.g., copy and/or multimedia files) from a particular corporation or contributor. In general, the co-branded web pages build affinity with employees of the corporation in programs and foster a positive feeling that the corporation has elected to award currency of giving to a particular employee. The co-branded web pages additionally provide information about corporation program(s) and the organization to employees. The co-branded web pages may serve as a starting point in the donation process, and once employees of the corporation decide to explore giving and make a gift, they may access functionality implemented by the giving module 535, described in further detail below.

The microsites module 530 is further configured to implement “templates” or a “template collection” that describe and offer a specific set of options to a contributor. The templates may generally vary in terms of form, content, and positioning of logos, copy blocks, and/or media files. In one embodiment, the templates include: (a) program home/welcome page; (b) program FAQs; and (c) what's hot/what's not news. Other embodiments are possible as well.

In event that a contributor has several “programs” in place, an institutional landing page may be implemented, also based on a template. In this example, a corresponding template may include user-sensitive information including only those programs in which a particular individual has been awarded currency of giving. A particular template may also be tailored to account for: (a) behavior when a returning individual signs in and there haven't been any new awards made to them since the last time they signed in; (b) when an individual signs in and there have been new awards made since the last time they signed in; (c) when an individual signs in and are only participating in a single program (e.g., be directed to that program's home page, rather than the landing page). Other embodiments are possible.

In example embodiments, templates may also include: (a) content blocks and/or pages under the system's control for system-wide announcements; and (b) e-mail templates with supporting content and logo image(s) provided by a particular contributor. Example e-mail templates include: (i) one where an individual has been awarded currency of giving because of a milestone (e.g., service anniversary) and (ii) one where an individual has been awarded currency of giving by a supervisor (e.g., spot recognition award for an accomplishment). Other embodiments are possible.

The giving module 535 is configured to implement web pages in which employees of the corporation make gifts or donations to NPO's. In one embodiment, these web pages are an entirely branded area, with the currency system setting the content and experience. Example experiences include: (a) an individual giving experience where an employee as an individual donates currency of giving to one or more NPO's; and (b) a team giving experience where a team that has been awarded currency of giving donates currency of giving to one or more NPO's. Other embodiments are possible.

In general, web pages implemented by the giving module 535 are branded according to the currency system. For individuals who start on a microsite, there will be a difference between the microsite to the giving experience in terms of branding and appearance. Such an implementation beneficially achieves the following qualitative or emotional effects: (a) a sense of independence in which an individual can donate to any NPO without feeling pressured or worried that their information will be unwittingly shared; (b) a sense that giving is easy and fun; (c) a sense of engagement; (d) a sense of coolness/uniqueness; and (e) a sense of pervasiveness or continuity in the form of a continuation from here into the individuals overall giving habits. Other embodiments are possible.

Still continuing with the example, the administrative module 540 is generally configured to implement a plurality of functionality associated with the application 405 including: (a) operations web pages that allow administrative users and other users with appropriate credentials to manage functionality of the application 405; (b) program management web pages that allow administrative users and a given contributor to manage functionality of the application 405; (c) NPO operations web pages that allow NPO users to work with basic NPO information and pull transaction reports; and (d) affiliate program management that allow administrative users and affiliate partner users to access and manage elements of the affiliate programs.

The administrative module 540 is further configured to define and manage user IDs and profiles. In general, each type of user generally has certain functional rights. In addition, most user types have rights to certain areas of information and not to others. Example users include: system administrator, contributors, and designees. Other types of users are possible.

In example embodiments, users include: (a) Administrator, or someone who is involved with platform or application 405 operations; and (b) Contributors, or someone who manages day-to-day operations of one or more programs.

Designees Additional users can include: (a) Program Manager, or someone who manages the day-to-day operations of one or more Contributor programs; (b) Supervisor, or someone with authority to award currency of giving, such as a supervisor participating in an employee recognition program; and (c) Report Viewer, or someone with authority to look at reports for one or more Contributor programs. Other types of Contributor Users are possible.

Designees generally include those who receive currency of giving awards and makes currency of giving gifts to NPOs. In general, this could also be a person who purchases currency of giving directly. End users are Designees may be linked to programs, and in addition to standard profile information (e.g., user IDs and profiles), a profile may further include: (a) opt-in/opt-out choices regarding receiving communication from the currency system outside a given program; (b) opt-in/opt-out choices for new features, including an opt-in to receive surveys from the currency system and others, and a global opt-in for whether to send personally identifiable information to NPOs; (c) properties that enable an end user to merge multiple identities into one identity; and (d) opt-in/opt-out choices to show profile information to other end users. Other embodiments are possible.

An NPO User is an employee at an NPO who has the right to create, update and maintain information about the NPO on the platform (i.e., application 405). In general, an NPO user may be enabled to: (a) claim an NPO profile (i.e., information about the NPO, not a particular user) so that another NPO User can start managing content about the NPO; (b) set up a User ID; (c) trigger e-mail to an end user to approve; (d) e-mail “next steps” to an NPO employee; (e) approve new NPO User IDs and to deactivate NPO User IDs; (f) change NPO user status; and (g) on approval, trigger welcome email. Other embodiments are possible.

An Affiliate Program User is a person who has joined a currency system affiliate program. An example of such a user might apply to join an affiliate program. In this example, a request will be triggered and someone at the currency system will review and approve the request. Upon approval, user status will change. In some embodiments, an organization or an end user may want to be an affiliate. Other embodiments are possible.

The administrative module 540 is further configured to manage currency of giving acquisition and allocation. Workflow related to the acquisition and allocation of currency of giving includes at least the following: (a) a contributor buys a quantity of currency of giving, and the transaction is recorded in and managed by a finance system; (b) accesses the application 405 and either (i) sets up a new program and set the amount of currency of giving that can be awarded in the program or (ii) changes the amount of currency of giving that can be awarded in an existing program; (c) as contributors award currency of giving, the application 405 will (i) reduce the amount of currency of giving that can be awarded in programs and (ii) create new Currency Accounts (where applicable) and (iii) deposit currency of giving in these accounts, where the application 405 tracks all transactions; (d) as designees make gifts to NPOs, the application 405 will (i) authorize those transactions and (ii) store those transactions; (e) at a predefined interval (e.g., weekly), the application 405 passes gift transactions to the finance system; and (f) on a predefined basis (e.g., monthly), the application 405 will go through currency of giving awards, identify awards that are older than a specified time interval (e.g., 6 months, 9 months, 12 months etc.) and that have not been gifted, and, if the contributor program is still active, un-assign the currency of giving and return the currency of giving to the program to be awarded.

In some embodiments, Currency Accounts are analogous to checking accounts at a bank. Currency Accounts contain currency of giving awarded to an end user for giving to NPOs. Like accounts at a bank, there will be deposit, authorization checks, and withdrawal transactions associated with them.

In general, there may be different types of Currency Accounts such as, for example: (a) Individual Designee, held by one person; and (b) Team Designees, held by more than one person because of a team award. In both scenarios, a number of properties are defined or assigned to the Currency Accounts including: (a) an e-mail reminder may be sent to an end user (e.g., quarterly) reminding each user of currency of giving that they have been awarded and that have not been donated; (b) at the time of withdrawal and at the time of calculating currency of giving expiration, a first-in/first-out method may be used for withdrawing currency of giving; (c) when a currency of giving is assigned, it will not be unassigned in normal course of business, for example, if Sally leaves Contributor XYZ, and has 50 ungifted units of currency of giving in one of that Contributor's programs, Sally has the right to gift them at any point up until they reach the 12-month “ungifted” mark; (d) balancing, or the ability to balance amounts deposited and amounts withdrawn and identify exceptions; and (e) feeds to the financial system. Other embodiments are possible.

The administrative module 540 is further configured to manage reporting functionality of the application 405. In general, end users are enabled to check the following currency of giving information at an aggregate level, at a transactional level, and filtered to a specific program: (a) Total Awards; (b) Total Gifts; (c) Total Amount Available to Give; and (d) tax message (e.g., “This is not a tax deduction for you”). Other embodiments are possible.

The administrative module 540 is further configured to define and manage “programs” or “program structures” of the application 405. In example embodiments, a program structure may include: (a) definitional information such as name, dates, and other essential facts; (b) the amount of currency of giving available to award in the program, and then, as awards are made, the current amount of currency of giving available to award and the amount already awarded; and (c) rule sets that define how currency of giving is rewarded.

Example rule set patterns include: (a) simple assignment (i.e., award Sally 150 units of currency of giving); (b) single or nested “if x then y” statements (e.g., if Sally has been with the company 10 years, then award 300 units of currency of giving); (c) single or nested “for every x then y” statements (e.g., for every 2 years of service, assign $100 units of currency of giving as an award); and (d) milestone-based (e.g., When someone reaches x, then award y.). Other embodiments are possible.

The application 405 also includes an integration module 532 that allows third party entities to communicate with the system. One example is an application programming interface (API) that allows individuals on third party web sites to communicate with the application 405. For example, the integration module 532 can be connected to such web sites as a corporate site, Facebook, My Space, Twitter, Google, etc. The integration module 532 allows a designee to interact with and gift currency of giving on the third party sites. In other examples, the integration module 532 can allow designees to use other forms of giving (e.g., airline miles, credit card points, etc.) for gifting. Other configurations are possible.

In some examples described herein, the contributor is a corporation or similar organization that contributes currency to be distributed to its employees. However, other embodiments are possible. For example, in other embodiments, organizations such as credit card companies and airlines can contribute currency and utilize loyalty programs to incentivize the organizations' customers to donate. For example, points awarded for credit card use or miles awarded for travel could be converted into currency of giving that can be used on the system (e.g., 1000 Skymiles=20 dollars of charitable currency).

Other uses include: organizations that use contributions to recognize social acts, volunteerism and community service; organizations and individuals use to teach philanthropy education to students (e.g., K-12, college students, citizenship, etc.); organizations use as stakeholder engagement tool to engage important groups outside their organizations; nonprofit organizations are enabled through an API to accept the charitable currency through their branded sites online; individuals purchase and use currency for themselves (personal donor advised fund model); and individuals purchase and reward to others for personal reasons like gifting, memorializing, etc.

In another example, the system can be configured to provide certain reporting details back to the contributor on a periodic or requested basis. Such reporting can include information like amount of currency of giving that has not be distributed, amount of currency of giving that has been distributed, amount of currency of giving that has been allocated by designees, amount of currency of giving that has not been allocated, etc.

In another alternative embodiment, the designee can allocate currency of giving by means other than computer. For example, the designee can interact with a telephonic system and/or provide written instructions (e.g., by regular mail or facsimile) to allocate the currency of giving.

The example embodiments described herein can be implemented as logical operations in a computing device in a networked computing system environment. The logical operations can be implemented as: (i) a sequence of computer-implemented operations, instructions, steps, or program modules running on a computing device; and (ii) interconnected logic or hardware modules running within a computing device.

For example, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer-readable storage medium, and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for implementing a currency system for giving, comprising:
receiving a donation to a donor-advised fund;
converting, by a computing system, the donation to an intermediate currency different than a currency of the donation;
receiving, at the computing system, instruction designating a gift for distribution to a recipient organization, the gift including at least a portion of the donation in the intermediate currency; and
transferring, from the computing system, the gift to the recipient organization.

2. The method of claim 1, further comprising:
receiving a first message, wherein the first message at least includes specification of a designee and an awarded currency amount.

3. The method of claim 2, wherein the awarded currency amount being at least a portion of the donation in the intermediate currency.

4. The method of claim 2, wherein the first message further includes specification of an award criterion.

5. The method of claim 4, wherein the award criterion includes a description designating a reason that the designee is awarded the awarded currency amount.

6. The method of claim 2, further comprising:
sending the designee a second message at least including specification of the awarded currency amount.

7. The method of claim 6, wherein the second message further includes specification of an award criterion.

8. The method of claim 7, wherein the award criterion includes a description designating a reason that the designee is awarded the awarded currency amount.

9. The method of claim 8, wherein the gift at least corresponds to the awarded currency amount.

10. The method of claim 9, further comprising:
sending a third message to the designee acknowledging the gift to the recipient organization.

11. The method of claim 1, further comprising:
receiving a first message, wherein the first message at least includes specification of purchase of a currency amount in the intermediate currency.

12. The method of claim 11, wherein the purchased currency amount at least corresponds to the gift transferred to the recipient organization.

13. A computing device, comprising:
a processing unit; and
a system memory connected to the processing unit, the system memory including instructions that, when executed by the processing unit, cause the processing unit to execute an application configured to implement a currency system for giving including:
receive a donation to a donor-advised fund;
convert the donation to an intermediate currency different than a currency of the donation;
receive a first trigger message, the first trigger message at least including specification of a designee and an awarded currency amount;
receive instruction designating a gift for distribution to a recipient organization, the gift at least corresponding to the awarded currency amount and including at least a portion of the donation in the intermediate currency; and
transfer the gift to the recipient organization.

14. The computing device of claim 13, wherein the first trigger message further including specification of an award criterion.

15. The computing device of claim 14, wherein the award criterion including a description designating a reason that the designee is awarded the awarded currency amount.

16. The computing device of claim 13, wherein the application is further configured to send the designee an award message at least including specification of the awarded currency amount.

17. The computing device of claim 16, wherein the award message further including specification of an award criterion designating a reason that the designee is awarded the awarded currency amount.

18. The computing device of claim 13, wherein the gift at least corresponds to the awarded currency amount, and wherein the application is further configured to send an appreciation message to the designee acknowledging the gift to the recipient organization.

19. The computing device of claim 13, wherein the application is further configured to receive a second trigger message, the second trigger message at least including specification of purchase of a currency amount in the intermediate currency, and wherein the purchased currency amount at least corresponding to the gift transferred to the recipient organization.

20. A computer-readable storage medium having computer-executable instructions that, when executed by a computing device, cause the computing device to perform steps comprising:
receiving a donation to a donor-advised fund;
converting the donation to an intermediate currency different than a currency of the donation;
receiving a first message, the first message specifying a designee, an awarded currency amount being at least a portion of the donation in the intermediate currency, and an award criterion designating a reason that the designee is awarded the awarded currency amount;
receiving instruction designating a gift representing at least a portion of the intermediate currency for distribution to a recipient organization;
transferring the gift to the recipient organization; and
sending a second message to the designee acknowledging the gift to the recipient organization.
